(19) United States
(12) Patent Application Publication
(10) Pub. No.: US 2018/0292143 A1
(43) Pub. Date: Oct. 11, 2018

(54) EDGE STRIPS WITH SURFACE STRUCTURE FOR PLATE HEAT EXCHANGER

(71) Applicant: LINDE AKTIENGESELLSCHAFT, Muenchen (DE)

(72) Inventors: Herbert AIGNER, Engelsberg (DE); Gunther MATHE, Emmerting (DE)

(73) Assignee: LINDE AKTIENGESELLSCHAFT, Muenchen (DE)

(21) Appl. No.: 15/766,668

(22) PCT Filed: Oct. 4, 2016
(86) PCT No.: PCT/EP2016/001640

§ 371 Date: Apr. 6, 2018

(30) Foreign Application Priority Data
Oct. 6, 2015 (EP) 15002856.1

(51) Int. Cl. F28D 9/00; B23K 1/00; B23K 1/008; B23K 1/19; B23K 1/20; F28F 3/02

(52) U.S. Cl. CPC F28D 9/0062; B23K 1/0012; B23K 1/008; B23K 2203/10; B23K 1/20; F28F 3/025; B23K 1/19

(57) ABSTRACT

The invention relates to a plate heat exchanger having a plurality of parallel heat exchanger passages which are separated from one another by separating plates. Each heat exchanger passage is delimited on at least one side by an edge strip, and each edge strip has a first surface and a second surface facing away from the first surface. The two surfaces are soldered to a respective paired separating plate. According to the invention, each of the two surfaces has a surface structure with a plurality of uniformly arranged elevations and depressions, and the distance from one elevation to an adjacent elevation or from one depression to an adjacent depression ranges from 0.1 mm to 2.5 mm.

The invention relates to a plate heat exchanger as claimed in claim 1.

Plate heat exchangers of this kind, in particular aluminum plate heat exchangers, are known from the prior art and are preferably brazed in a furnace. Plate heat exchangers of this kind are described for example in the ALPEMA standard “The standards of the brazed Aluminium Plate-Fin Heat Exchanger Manufacturers Association”, Third Edition 2010 on p. 5, FIG. 1-2, and have a plurality of parallel heat exchange passages which are separated from one another by partition plates or partition sheets, wherein each heat exchange passage is bounded on at least two sides by in each case one edge strip that has a first surface and a second surface oriented away from the first surface, wherein each of the two surfaces is connected by brazing to an associated partition plate.

Proceeding from this, the present invention is based on the object of improving the edge strips used hitherto in order to simplify brazing of the edge strips to the partition plates and to improve the strength of the brazed connection.

This problem is solved with a plate heat exchanger having the features of claim 1. Advantageous configurations of the invention are provided in the subclaims and are described below.

Claim 1 provides a plate heat exchanger having a plurality of parallel heat exchange passages that are separated from one another by partition plates, wherein the respective heat exchange passage is bounded on at least two sides by in each case one edge strip, wherein the respective edge strip has a first surface and a second surface oriented away from the first surface, and wherein each of the two surfaces is connected by brazing to an associated partition plate. According to the invention, it is provided that the two surfaces each have a surface structure with a plurality of regularly arranged elevations and depressions, wherein the distance from one elevation to an adjacent elevation, or from one depression to an adjacent depression, is in the range from 0.1 mm to 2.5 mm.

Such edge strips, which are also referred to as sidebars, are usually produced by extrusion/drawing and, as per the prior art, have a relatively smooth surface which has an approximate average roughness depth (also referred to as the ten-point height) of R_{z}=10 μm. This average roughness depth is determined using known methods by dividing a defined measurement path on the surface of the workpiece into seven individual measurement paths, the middle five measurement paths being of identical size. Evaluation is performed only using these five measurement paths, a Gaussian filter being applied thereto in a known manner. The difference between the maximum and minimum values is determined for each of these individual measurement paths of the profile. The five individual roughness depths obtained in this manner are averaged to obtain the average roughness depth.

Owing to the relatively smooth surfaces of the edge strips (sidebars) in the prior art, there is the risk of leakage due to manufacturing tolerances and an increased risk of the edge strips floating during the brazing process.

The surface structure according to the invention makes it possible for the respective surface to dip in a defined manner into the brazing material layer of the partition sheet, and thus for the possibility of leaks, which arise due to edge strips at the lower end of the height tolerance or due to inadequate wetting of the brazing material, to be markedly reduced. The surface structures also make it possible to advantageously prevent edge strips slipping or floating during the brazing process. This is possible because the surface structures bring about a defined increase in the surface pressure, as a consequence of which the liquid brazing material can be displaced in a defined manner.

Furthermore, the surface structures according to the invention mean that the brazing material is also better distributed over the two surfaces of the edge strips. Differences in level, relative to a middle plane between elevations and depressions or between wave peaks and wave troughs, can be equalized, for example in the event that differences in level arise, in the brazing furnace, between the sidebar end faces (defined by a breadth and a height).

It is also provided, according to a preferred embodiment of the plate heat exchanger according to the invention, that the first and/or the second surface structure respectively has an average roughness depth R_{z} of greater than 15 μm, particularly preferably greater than 30 μm, more particularly preferably greater than 45 μm. Preferably, the upper limit of the roughness depth range according to the invention is R_{z}=1000 μm, particularly preferably R_{z}=800 μm, more particularly Rz=500 μm.

It is also provided, according to a preferred embodiment of the plate heat exchanger according to the invention, that the surface structures of the two surfaces are each formed by a plurality of depressions extending parallel to one another, wherein in each case two adjacent depressions are separated from one another by an elevation.

It is also provided, according to a preferred embodiment of the plate heat exchanger according to the invention, that the depressions have the same shape and size in cross section, and/or that the elevations have the same shape and size in cross section.

It is also provided, according to a preferred embodiment of the invention, that the respective edge strip is elongate along a longitudinal axis, that is to say has a greater extent along the longitudinal axis than perpendicular to the longitudinal axis. In that context, it is preferably provided that the depressions and/or elevations also extend parallel to the longitudinal axis.

The edge strips respectively have a length along the longitudinal axis, the edge strips having, perpendicular to the longitudinal axis, a height in a direction running respectively normal to the adjoining partition plates. The edge strips also have a breadth perpendicular to the longitudinal axis or length and perpendicular to the height.

It is also provided, according to a preferred embodiment of the invention, that the breadth of the respective edge strip is in the range from 10 mm to 50 mm, preferably in the range from 15 mm to 30 mm.

It is also provided, according to a preferred embodiment of the invention, that the height of the respective edge strip is in the range from 3 mm to 14 mm, preferably in the range from 4 mm to 10 mm.

It is also provided, according to a preferred embodiment of the invention, that a height difference (also referred to as the amplitude of the surface structure) between a lowest point of a depression and a highest point of an adjacent elevation is greater than 0.015 mm, particularly preferably greater than 0.030 mm, and more particularly preferably greater than 0.045 mm, and preferably not more than 1 mm, particularly preferably not more than 0.8 mm and more preferably not more than 0.5 mm. In that context, the height difference is measured in the direction of a normal to the respective surface of the edge strip.

It is in particular provided, as already stated above, that the distance between the lowest points of two adjacent depressions, perpendicular to the longitudinal axes thereof, or the distance between the highest points of two adjacent elevations, perpendicular to the longitudinal axes thereof, is in the range from 0.1 mm to 2.5 mm.

Preferably, according to one embodiment of the invention, the surface structures of the two sides of the respective edge strip are in each case in the form of a wave structure. That is to say that the depressions are preferably in the form of concave wave troughs and the elevations are preferably in the form of convex wave peaks.

In this context, it is preferably provided, according to one embodiment of the invention, that the radius of the convex curvature of the respective elevation and/or the radius of the concave curvature of the respective depression is in the range from 0.1 mm to 1.0 mm, preferably in the range from 0.2 mm to 0.8 mm, the respective radius lying in a plane perpendicular to the longitudinal axis.

According to another embodiment of the invention, it is provided that the respective depression is in each case formed by two converging flanks which meet at a lowest point of the respective depression, and wherein the respective elevation is in each case formed by two converging planar flanks which meet at a highest point of the respective elevation. This forms, on the first and/or second surface, a surface structure having a sawtooth profile in cross section.

According to another embodiment of the invention, it is provided that the respective depression is formed by a planar base and two mutually opposite planar flanks which depart therefrom, and wherein the respective elevation is in each case formed by a planar roof and two mutually opposite flanks which depart therefrom, wherein the bases run parallel to the roofs.

In this context, it can be provided, according to an embodiment of the invention, that the flanks of the respective depression run parallel to one another and perpendicular to the base of the respective depression, and that the flanks of the respective elevation run parallel to one another and perpendicular to the roof of the respective elevation. This forms, on the first and/or second upper side, a surface structure having a rectangular profile in cross section.

In an alternative embodiment, it is also provided that the flanks of the depressions diverge starting from the base of the respective depression, and that the flanks of the respective elevation converge in the direction of the roof of the respective elevation. In other words, this corresponds in cross section to a sawtooth profile having flattened bases of the depressions and flattened roofs of the elevations.

In another, alternative embodiment, it is provided that the flanks of the depressions converge starting from the base of the respective depression, and that the flanks of the respective elevation diverge in the direction of the roof of the respective elevation. This forms, on the first and/or second upper side, a surface structure having a dovetail profile in cross section.

It is also provided, according to a preferred embodiment of the invention, that the respective edge strip has an inner side which is oriented toward the respective heat exchange passage that is bounded by the edge strip, and an outer side which is oriented away from the inner side and in particular forms part of the outer side of the plate heat exchanger. The inner side of the respective edge strip connects the first surface of the respective edge strip to the second surface of the respective edge strip. In the same way, the outer side also connects the first surface to the second surface of the respective edge strip.

According to a preferred embodiment of the invention, it is provided that the inner side and/or the outer side of the respective edge strip each have two faces converging toward a roof. In this regard, it is provided, according to an embodiment of the invention, that the respective roof has a height in the range from 1 mm to 8 mm. Such roofs are also known as noses.

These roofs or noses of the inner and/or outer side advantageously prevent heat-conducting structures (referred to as fins or lamellas) in the respective heat exchange passage slipping under the respective edge strip during the brazing process, and prevent the respective edge strip slipping over a web of such a structure.

The roofs/noses preferably have a triangular shape in cross section perpendicular to the longitudinal axis, a tip of the respective roof preferably being rounded.

It is provided, according to a preferred embodiment of the invention, that the respective roof of an inner or outer side has a height in the range from 1 mm to 8 mm, particularly preferably a height in the range from 1 mm to 5 mm.

The two surfaces of the respective edge strip can in particular also have different surface structures or combinations of the structures described herein. It is thus possible, for example, for one surface to have a wave profile as the surface structure while the other surface has a sawtooth profile, etc.

Furthermore, the plate heat exchanger preferably has, in each of the individual heat exchange passages, a heat-conducting structure which is in each case arranged between two mutually opposite partition plates that respectively bear against the heat-conducting structure and are preferably connected thereto by brazing. The heat-conducting structures serve to take up heat and to convey heat to adjoining components, for example partition plates, of the plate heat exchanger.

As is the case for the edge strips, the heat-conducting structures are preferably made of an aluminum. The two outermost partition plates of the plate heat exchanger are also referred to as cover plates. Accordingly, there are in particular two outermost heat exchange passages which are each bounded by a cover plate and a partition plate.

The heat-conducting structures can, according to an embodiment of the invention, be planar, plate-like elements which extend along a plane of extent, namely parallel to the partition plates, and which have a wave-shaped profile in a cross-sectional plane running perpendicular to the plane of extent. Other such profiles are also conceivable. Heat-conducting structures of this kind are also termed fins or lamellas. The heat-conducting structures preferably respectively form, together with the adjoining partition plates, a plurality of channels which are in particular parallel and in which the respective heat transfer medium (e.g. a fluid) can be conducted.

As already explained in the introduction, the individual passages are bounded at both sides, or at multiple or all sides, by the edge strips (sidebars) according to the invention, which are also preferably made of an aluminum.

The flows (e.g. Fluids) participating in the exchange of heat are preferably conducted in adjacent heat exchange passages so that they are able to exchange heat.

The plate heat exchanger has, for the purpose of introducing a flow into associated heat exchange passages, a header with a port via which the relevant flow can be introduced into the associated passages of the plate heat exchanger. In that context, the header can be welded to the plate heat exchanger. If multiple flows are to be introduced into associated passages, the plate heat exchanger preferably has a corresponding number of headers with ports.

In order to extract the one or more flows from the respectively associated passages, the plate heat exchanger also preferably has a corresponding number of headers with ports via which the respective flow can be extracted from the plate heat exchanger.

The headers are in each case designed to distribute, to the individual passages, the flow that is to be introduced, or to collect the flow that is to be extracted, so that this flow can be extracted via the port provided on the header.

Another aspect of the invention relates to a method for producing a plate heat exchanger, involving the provision of at least one edge strip having a first surface and a second surface oriented away from the first surface, wherein the two surfaces are processed, in particular after the creation of a strip form for the at least one edge strip, so that the two surfaces each have a surface structure with a plurality of regularly arranged elevations and depressions, and wherein each of the two surfaces is connected by brazing to an adjacent partition plate, and wherein the distance from one elevation to an adjacent elevation, or from one depression to an adjacent depression, is in the range from 0.1 mm to 2.5 mm.

According to one embodiment of the method according to the invention, the surface structure is created by a drawing process, e.g. by the (for example extruded) edge strips being guided or drawn through an appropriate matrix which introduces the surface structure into both surfaces of the respective edge strip.

According to one alternative embodiment of the method according to the invention, the respective surface structure is created by rolling or by chip-removing machining.

Using the edge strips having a surface structure according to the invention, the plate heat exchanger can otherwise be produced in a known manner by arranging on one another components of the heat exchanger, such as the partition plates, the edge strips and the heat-conducting structures, with brazing material being provided between any two components that are to be joined, and by brazing together, in a furnace, the components arranged on one another.

Subsequently, the aforementioned headers and ports can be welded to the plate heat exchanger block, produced in this manner, of the plate heat exchanger.

Further details and advantages of the invention are explained by the following descriptions of figures of exemplary embodiments on the basis of the figures, in which:

### BRIEF DESCRIPTION OF THE DRAWINGS

FIG. 1 shows a plate heat exchanger according to the invention with surface-structured edge strips;

FIG. 2 shows a schematic section view of a heat-conducting structure (fin) of the type in FIG. 1;

FIG. 3 is a cross-sectional view of an edge strip according to the invention having wave-shaped surface structures, a detail being denoted by a frame and the numeral III;

FIG. 4 shows the detail III of FIG. 3;

FIG. 5 is a cross-sectional view of another edge strip according to the invention having sawtooth-shaped surface structures, a detail being denoted by a frame and the numeral III;

FIG. 6 shows the detail III of FIG. 5;

FIG. 7 is a cross-sectional view of another edge strip according to the invention having rectangular surface structures, a detail being denoted by a frame and the numeral III;

FIG. 8 shows the detail III of FIG. 7;

FIG. 9 is a cross-sectional view of another edge strip according to the invention having flattened sawtooth-shaped surface structures, a detail being denoted by a frame and the numeral III;

FIG. 10 shows the detail III of FIG. 9;

FIG. 11 is a cross-sectional view of another edge strip according to the invention having dovetail-shaped surface structures, a detail being denoted by a frame and the numeral III; and

FIG. 12 shows the detail III of FIG. 11.

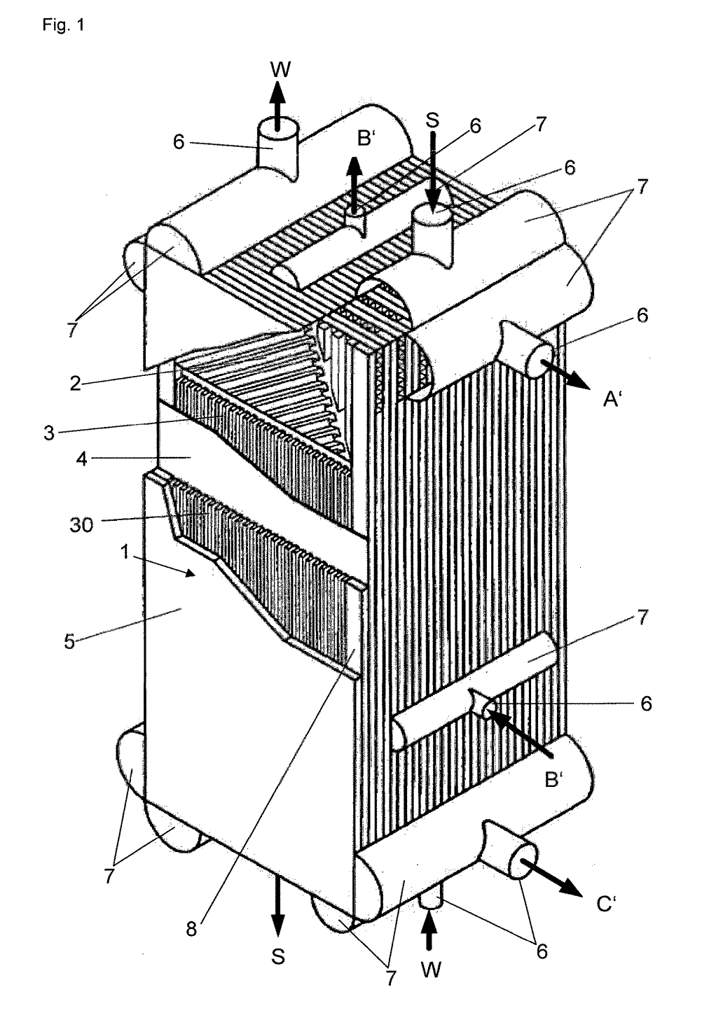

FIG. 1 shows a plate heat exchanger 1 which is configured for the exchange of heat between at least two flows S, W, wherein heat exchange possibilities for further process flows A′, B′, C′ can optionally be provided. The plate heat exchanger 1 is of block-shaped design and is equipped with a wide variety of means 6 for supplying and removing the individual process media S, W, these being also termed ports. The plate heat exchanger 1 also has multiple means 7 for distributing and collecting the individual process flows S, W and, where relevant, A′, B′, C′, wherein these are also termed headers and can be welded to the heat exchanger block.

The plate heat exchanger 1 has a multiplicity of heat exchange passages (passages for short) 30 which are arranged in the form of a stack, are separated from one another by partition plates (e.g. partition sheets) 4 and are bounded outwardly on both sides by partition plates 5 that are also termed cover plates (e.g. cover sheets) 5. The various media S, W flow in the individual passages 30. The heat exchange takes place indirectly by the thermal contact that is established by the partition plates 4 and by the heat-conducting structures 3 arranged in the passages 30.

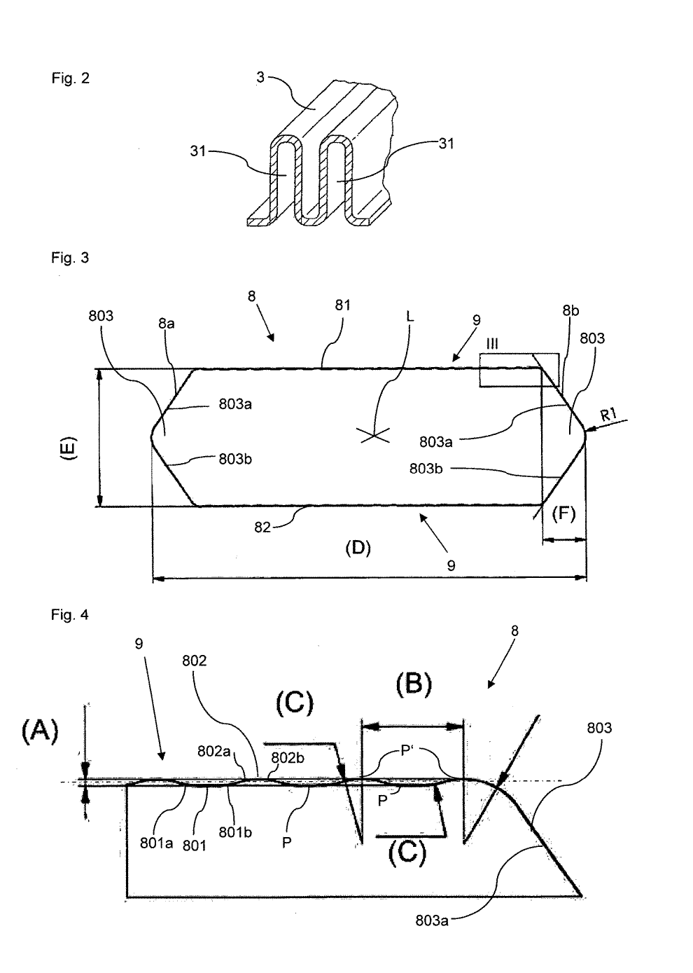

The respective heat-conducting structure 3 can be a wave-shaped structure 3 which is also referred to as a fin or lamella 3 and which can have a wave-shaped profile in cross section. However, such a profile can also be a profile which has a different shape and which, together with the two adjoining partition plates, forms in each case a multiplicity of parallel channels 31, arranged next to one another, for a fluid (see FIG. 2). The individual fins 3, together with the two respectively adjoining partition plates 4 and 5, each bound a passage 30 of the plate heat exchanger 1.

The individual media S and W are introduced into the headers 7 by way of the ports 6 and thus distributed among the respectively provided passages 30 that are arranged in the form of a stack. Arranged in the inlet region of the passages 30 are so-called distributor fins 2, which provide a uniform distribution of the medium S, W within the individual passages 30. The media S, W consequently flow through the passages 30 transversely to the wave direction of the fins 3. The heat-conducting structures 3 are connected to the partition sheets 4 by brazed connections, whereby an intensive heat-conducting contact is established. Thus, heat can be exchanged between two different media S, W flowing in adjacent passages 30. As seen in the direction of flow, at the end of the passage 30 there are similar distributor fins 2, which conduct the media S, W out of the passages 30 and into the headers 7, where they are collected and extracted by way of the ports 6.

The individual passages 30 are closed off outwardly by edge strips 8, also known as sidebars.

The plate heat exchanger 1 is preferably brazed. The individual passages 30 with the fins 3, distributor fins 2, partition plates 4, cover plates 5 and sidebars 8 are stacked one on top of the other, provided with brazing material and brazed in a furnace. Headers 7 and ports 6 are then welded onto the block created in this manner.

In order to improve the brazed connections between the edge strips 8 and the partition plates 4 as described above, it is provided that the respective edge strip 8 has a first surface 81 and a second surface 82 oriented away from the first surface 81, wherein the two surfaces 81, 82 each have a surface structure 9.

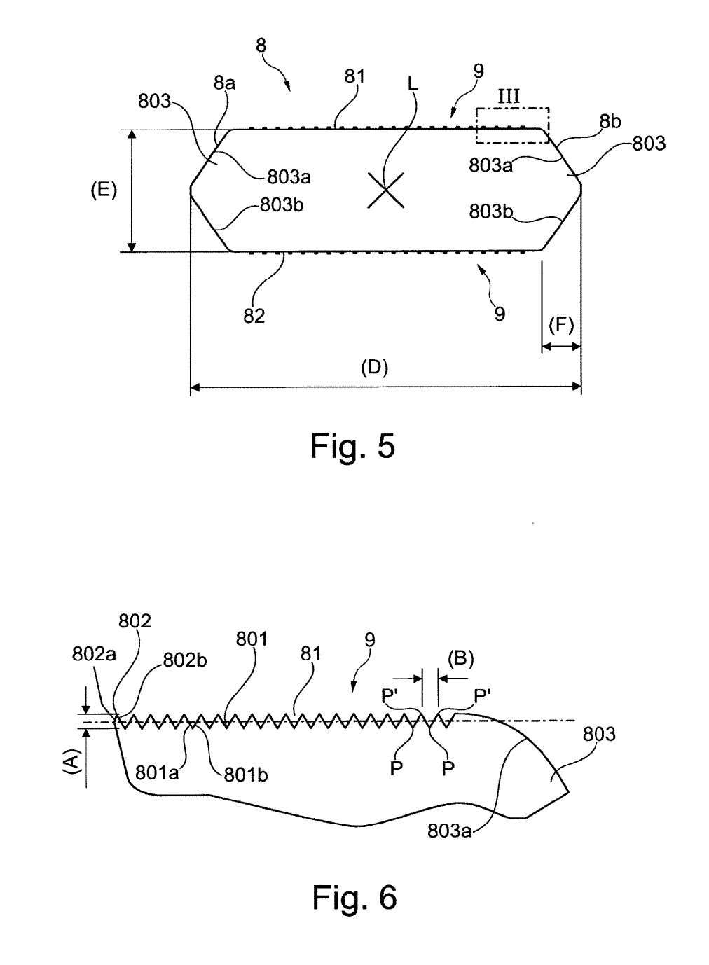

This is for example, as per FIGS. 3 and 4, a wave structure 9 respectively formed by a plurality of grooves or depressions 801 extending parallel to one another, wherein any two adjacent depressions 801 are separated from one another by an elevation 802, with the elevations 802 also running parallel to one another. In that context, the depressions 801 and elevations 802 extend along a longitudinal axis L which, in FIGS. 3 and 4 (and in FIGS. 5 to 12), is perpendicular to the sheet plane, wherein the depressions 801 have concave curvature in the indicated cross section running perpendicular to the longitudinal axis L. By contrast, the elevations 802 have convex curvature in the cross section running perpendicular to the longitudinal axis L. The radius C of these curvatures is preferably in the range from 0.1 mm to 1.0 mm.

Furthermore, the height difference A between the lowest point P of the respective depression 801 and the highest point P′ of the respectively adjacent elevation 802 is in the range from 0.015 mm to 1.0 mm.

The distance B of any two adjacent elevations 802, or of any two adjacent depressions 801, perpendicular to the longitudinal axis L is preferably in the range from 0.1 mm to 2.5 mm.

Furthermore, a breadth D of the respective edge strip 8 (in this case from roof peak 803 to roof peak 803, cf. also below) is in the range from 10 mm to 50 mm.

Furthermore, the height E of the respective edge strip 8, i.e. the distance between the first and second surface 81, 82, can be in the range from 3 mm to 14 mm.

Furthermore, the respective edge strip 8 has an inner side 8a which is oriented toward the respective passage 30 that is bounded by the edge strip 8, and an outer side 8b which forms part of the outer side of the plate heat exchanger 1.

According to FIG. 3, the edge strip 8 further has, on both the inner side 8a and on the outer side 8b, a roof 803 which is formed by two converging faces 803a, 803b and accordingly has, in cross section perpendicular to the longitudinal axis L, a triangular shape with a rounded peak. The two roofs 803 can each have a height F which can be in the range from 1 mm to 8 mm.

The above indications of length A to F merely represent preferred ranges. Other dimensions are also conceivable.

As shown in FIGS. 1 and 2, the edge strips 8 according to the invention are arranged on the outer edges of the partition plates 4 or cover plates 5 as a lateral boundary for the respective heat exchange passage 30, and therefore adjacent edge strips 8 are arranged next to one another with in each case a partition plate 4 interposed between them, and any roofs 803 present on the respective inner side 8a maintain a distance to the heat-conducting structure 3 of the relevant passage 30 so that these cannot find their way under the respectively adjoining edge strip 8 during the brazing process. The two surfaces 81, 82 of the respective edge strip 8 are brazed over their entire surface area with the partition plate 4 or cover plate 5 respectively in contact therewith.

FIG. 5 shows, in conjunction with FIG. 6, another edge strip 8 according to the invention, of the type shown in FIGS. 3 to 4, wherein the two surface structures 9 of the two surfaces 81, 82 are once again formed by a plurality of mutually parallel depressions 801 extending along the longitudinal axis L, wherein an elevation 802 is arranged between each two adjacent depressions 801 of a surface structure 9. In contrast to FIGS. 3 and 4, the respective depression 801 is now formed by two convergent planar flanks 801a, 801b which meet at a lowest point P of the respective depression 801. By contrast, the respective elevation 802 is formed by two convergent planar flanks 802a, 802b which meet at a highest point P′ of the respective elevation 802. Preferably, the flanks 801a, 801b of the depressions 801 respectively transition into the adjoining flanks 802a or 802b of the adjacent elevations 802. The above-mentioned indications of length A to F of FIGS. 3 and 4 can also be used for the exemplary embodiment shown in FIGS. 5 and 6.

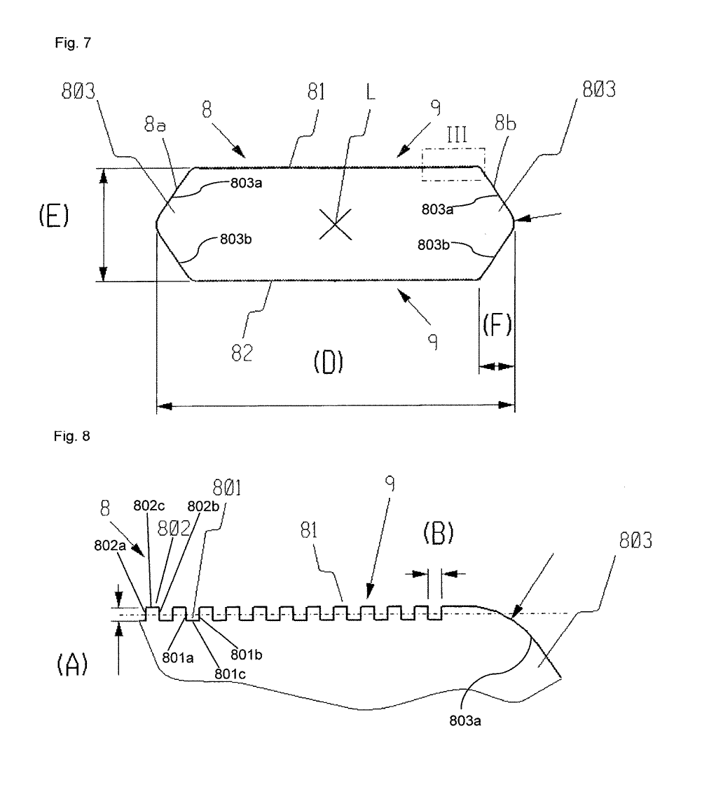

FIGS. 7 and 8 show another embodiment of an edge strip 8 according to the invention, of the type shown in FIGS. 3 to 6, wherein in this case in contrast to the embodiments shown in FIGS. 3 to 6, the respective depression 801 is formed by a planar base 801c that extends in each case along the longitudinal axis L, parallel to the plane of extent of the associated surface 81 or 82 of the edge strip 8, and by two mutually opposite planar flanks 801a, 801b departing perpendicularly from the base, such that the depressions 801 have a rectangular shape in cross section. Conversely, the respective elevation 802 is formed in each case by one planar roof 802c, with the roofs 802c running parallel to the bases 801c, and by in each case two mutually opposite and spaced-apart planar flanks 802a, 802b departing perpendicularly from the respective roof 802c. This produces, in cross section, a rectangular surface profile with depressions 801 and elevations 802 that are rectangular in cross section.

In the example of the edge strip 8 shown in FIGS. 7 and 8, the height E, the breadth D, the height F and the height difference A can for example take on the values stated for FIGS. 3 to 6. Furthermore, the distance B between two adjacent elevations 802, or the distance B between two adjacent depressions 801 can, according to FIG. 8, lie for example in the range from 0.1 mm to 2.5 mm.

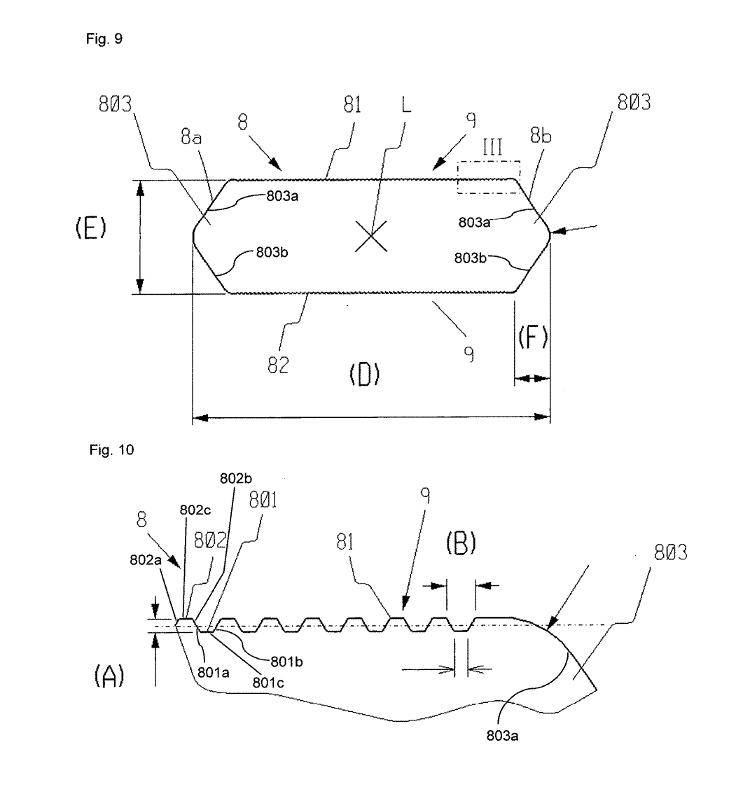

FIGS. 9 and 10 show another embodiment of an edge strip according to the invention, of the type shown in FIGS. 7 and 8, in which in contrast to FIGS. 7 and 8 the flanks 801a, 801b of the depressions 801 now diverge proceeding from the respective base 801c of the respective depression 801. It is also provided, in contrast to FIGS. 7 and 8, that the flanks 802a, 802b of the respective elevation 802 converge in the direction of the roof 802c of the respective elevation 802. The above-mentioned indications of length A, D, E and F of FIGS. 3 to 8 can also be used for the exemplary embodiment shown in FIGS. 9 and 10. The distance B between two adjacent elevations 802 can be, for example at the level of the roofs 802c, in the range from 0.1 mm to 2.5 mm.

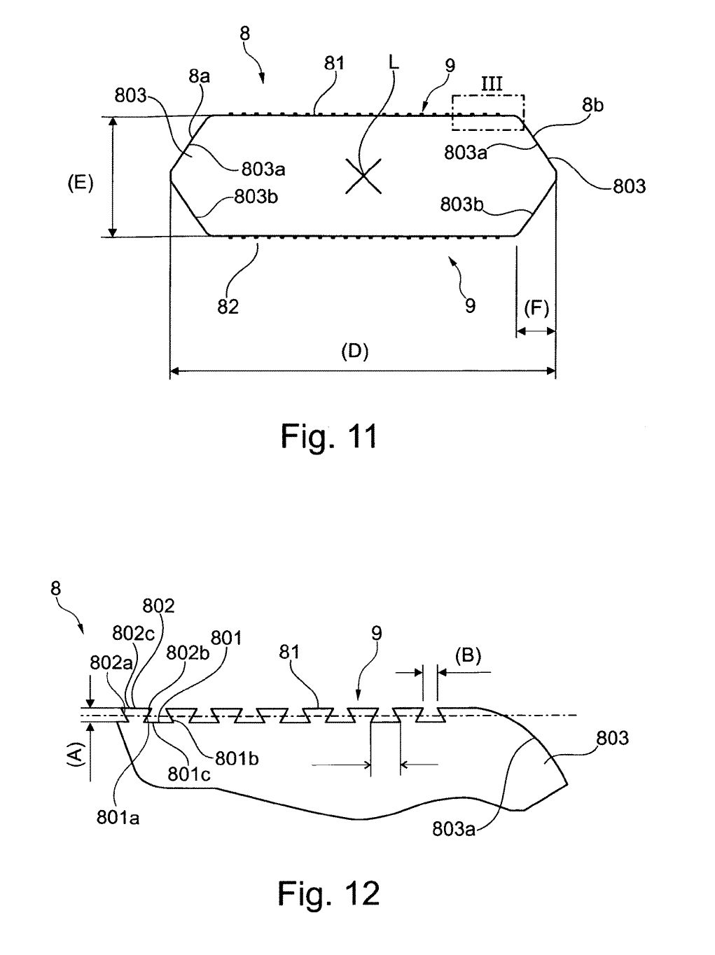

Finally, it is provided according to another embodiment (cf. FIGS. 11 and 12) that, in contrast to FIGS. 9 and 10, the flanks 801a, 801b of the depressions 801 converge proceeding from the respective base 801c of the respective depression 801. Here, too, it is provided that the flanks 802a, 802b of the respective elevation 802 diverge in the direction of the roof 802c of the respective elevation 802, so that the surface structures 9 are designed as a dovetail profile in cross section. The above-mentioned indications of length A, D, E and F of FIGS. 3 to 10 can also be used for the exemplary embodiment shown in FIGS. 11 and 12. The distance B between two adjacent elevations 802 can be, for example at the level of the roofs 802c, in the range from 0.1 mm to 2.5 mm.

List of reference signs

| | |
|---|---|
| 1 | Plate heat exchanger |
| 2 | Distributor fin |
| 3 | Heat-conducting structure (fin) |
| 4 | Partition plates |
| 5 | Cover plates |
| 6 | Port |
| 7 | Port |
| 8 | Edge strip |
| 8a | Inner side |
| 8b | Outer side |
| 9 | Surface structure |
| 30 | Heat exchange passage |
| 31 | Channels |
| 81 | First surface |
| 82 | Second surface |
| 801 | Depression |
| 801a, 801b, 802a, 802b | Flanks |
| 801c | Floor |
| 802 | Elevation |
| 802c | Roof |
| 803 | Roof or nose |
| 803a, 803b | Faces |
| A′, B′, C′, S, W | Media |
| A | Height difference |
| B | Distance |
| C | Radius |
| D | Breadth |
| E | Height |
| F | Height of roof |
| L | Longitudinal axis |
| P | Lowest point of depression |
| P′ | Highest point of elevation |

1. A plate heat exchanger (1) having a plurality of parallel partition plates (4, 5) which define heat exchange passages (30), wherein the respective heat exchange passage (30) is bounded on each of at least two sides by an edge strip (8), wherein the respective edge strip (8) has a first surface (81) and a second surface (82) oriented away from the first surface (81), and wherein each of the two surfaces (81, 82) is connected by brazing to an associated partition plate (4), wherein the two surfaces (81, 82) each have a surface structure (9) with a plurality of regularly arranged elevations (802) and depressions (801),
characterized
in that the distance (B) from one elevation to an adjacent elevation (802), or from one depression to an adjacent depression (801), is in the range from 0.1 mm to 2.5 mm.

2. The plate heat exchanger as claimed in claim 1, characterized in that the surface structures (9) of the two surfaces (81, 82) of the respective edge strip (8) are each formed by a plurality of depressions (801) extending parallel to one another, wherein in each case two adjacent depressions (801) are separated from one another by an elevation (802).

3. The plate heat exchanger as claimed in claim 1, characterized in that both surface structures (9) each have an average roughness depth (R_{z}) of greater than 15 μm, in particular of greater than 30 μm.

4. The plate heat exchanger as claimed in claim 1, characterized in that the respective edge strip (8) is elongate along a longitudinal axis (L).

5. The plate heat exchanger as claimed in claim 4, characterized in that the respective edge strip (8) has, perpendicular to the longitudinal axis (L), a height (E) in a direction running normal to the adjoining partition plates (4, 5), and wherein the respective edge strip (8) has, perpendicular to the longitudinal axis (L) and perpendicular to the height (E), a breadth (D), wherein in particular the breadth (D) of the respective edge strip (8) is in the range from 10 mm to 50 mm, and wherein in particular the height (E) of the respective edge strip (8) is in the range from 3 mm to 14 mm.

6. The plate heat exchanger as claimed in claim 4, characterized in that the depressions (801) and/or the elevations (802) extend parallel to the longitudinal axis (L).

7. The plate heat exchanger as claimed in claim 1, characterized in that a height difference (A) between a lowest point of a depression (801) and a highest point of an elevation (802) is in the range from 0.10 mm to 1.00 mm.

8. The plate heat exchanger as claimed in claim 1, characterized in that the depressions (801) form concave wave troughs and the elevations (802) form convex wave peaks.

9. The plate heat exchanger as claimed claim 1, characterized in that the respective depression (801) is in each case formed by two converging planar flanks (801a, 801b) which meet at a lowest point (P) of the respective depression (801), and wherein the respective elevation (802) is in each case formed by two converging planar flanks (802a, 802b) which meet at a highest point (P′) of the respective elevation (802).

10. The plate heat exchanger as claimed in claim 1, characterized in that the respective depression (801) is formed by a planar base (801c) and two mutually opposite planar flanks (801a, 801b) which depart therefrom, and wherein the respective elevation (802) is in each case formed by a planar roof (802c) and two mutually opposite planar flanks (802a, 802b) which depart therefrom, wherein the bases (801c) run parallel to the roofs (802c).

11. The plate heat exchanger as claimed in claim 10, characterized in that the flanks (801a, 801b) of the respective depression (801) run parallel to one another and perpendicular to the base (801c) of the respective depression (801), and in that the flanks (802a, 802b) of the respective elevation (802) run parallel to one another and perpendicular to the roof (802c) of the respective elevation (802).

12. The plate heat exchanger as claimed in claim 10, characterized in that the flanks (801a, 801b) of the depressions (801) diverge starting from the base (801c) of the respective depression (801), and in that the flanks (802a, 802b) of the respective elevation (802) converge in the direction of the roof (802c) of the respective elevation (802).

13. The plate heat exchanger as claimed in claim 10, characterized in that the flanks (801a, 801b) of the depressions (801) converge starting from the base (801c) of the respective depression (801), and in that the flanks (802a, 802b) of the respective elevation (802) diverge in the direction of the roof (802c) of the respective elevation (802).

14. The plate heat exchanger as claimed claim 1, characterized in that the respective edge strip (8) has an inner side (8a) oriented toward the associated heat exchange passage (30) and an outer side (8b) oriented away from the inner side (8a), wherein the inner side (8a) and the outer side (8b) in each case connect the first surface (81) to the second surface (82), wherein in particular the inner side (8a) and/or the outer side (8b) have in each case two faces (803a, 803b) which converge toward a roof (803), and wherein preferably the respective roof (803) has a height (F) in the range from 1 mm to 8 mm.

15. A method for producing a plate heat exchanger (1), involving the provision of at least one edge strip (8) having a first surface (81) and a second surface (82) oriented away from the first surface (81), wherein the two surfaces (81, 82) are processed so that the two surfaces (81, 82) each have a surface structure (9) with a plurality of regularly arranged elevations (802) and depressions (801), and wherein each of the two surfaces (81, 82) is connected by brazing to an adjacent partition plate (4), and wherein the distance (B) from one elevation to an adjacent elevation (802), or from one depression to an adjacent depression (801), is in the range from 0.1 mm to 2.5 mm.
